(19) United States
(12) Patent Application Publication
(10) Pub. No.: US 2014/0029935 A1
(43) Pub. Date: Jan. 30, 2014

(54) INDICATING A SYNCHRONIZATION POINT BETWEEN A TRANSMITTER AND A RECEIVER OF AN OPTICAL LINK

(71) Applicants: James Donald Regan, Fort Collins, CO (US); Peter David Maroni, Windsor, CO (US); Daniel Alan Berkram, Loveland, CO (US)

(72) Inventors: James Donald Regan, Fort Collins, CO (US); Peter David Maroni, Windsor, CO (US); Daniel Alan Berkram, Loveland, CO (US)

(21) Appl. No.: 13/560,509

(22) Filed: Jul. 27, 2012

(51) Int. Cl. H04B 10/08

(52) U.S. Cl. 398/25

(57) ABSTRACT

A receiver receives a predetermined pattern over an optical link from a transmitter. In response to detecting that the predetermined pattern satisfies at least one criterion, indicating that a synchronization point has been reached to allow link training of the optical link to be performed between the transmitter and receiver.

### BACKGROUND

Transmitters and receivers are used to perform communications over an optical link between communication devices. A transmitter is used to transmit an optical signal over the optical link, where the optical signal is received by a receiver. Before a transmitter and a receiver can successfully communicate data over an optical link, a link training process is performed over the optical link between the transmitter and the receiver. The link training process can be used to recognize capabilities of the communication devices on both ends of the optical link, to negotiate link frequencies, and so forth.

### BRIEF DESCRIPTION OF THE DRAWINGS

Some embodiments are described with respect to the following figures:

FIG. 1 is a schematic diagram of an example arrangement that includes communication devices coupled over an optical link, where the communication devices have transmitters and receivers according to some implementations;

FIG. 2 is a flow diagram of a synchronization process according to some implementations;

FIG. 3 is a timing diagram depicting a slow pattern and a core clock, according to some implementations;

FIG. 4 is a state machine that provides two filtering stages, in accordance with some implementations; and

FIGS. 5A-5B illustrate example topologies of an optical link, according to some implementations.

### DETAILED DESCRIPTION

Communication devices (e.g. computers, storage devices, network devices, input/output (I/O) devices, processors, memory devices, etc.) that are coupled over an optical link can include transmitters and receivers that are used for transmitting optical signals and receiving optical signals, respectively. Examples of optical links include optical fibers, optical waveguides, and so forth.

In some implementations, the transmitters and receivers of the communication devices on the two ends of the optical link can use different core clock frequencies. A “core clock” refers to an oscillating signal having a particular frequency in a given communication device, where the oscillating signal is produced by a clock source that has an oscillator. The core clock can be used to drive various electrical circuitry in the transmitter or receiver.

At the transmitter, the electrical circuitry can include a signal driver that produces output electrical signals corresponding to data bits to be communicated. The electrical signals from the signal driver are provided to an optical element such as a laser diode, which is able to convert the electrical signals into corresponding optical signals that are transmitted over the optical link. The signal driver can be clocked by a core clock of the transmitter. An example of a laser diode is a vertical-cavity surface-emitting laser (VCSEL). Other examples of optical elements for transmitting optical signals can also be employed.

At the receiver, received optical signals are converted by an optical element, such as a photo diode or other type of photo detector, into electrical signals that are processed by electrical circuitry at the receiver. The electrical circuitry at the receiver can be clocked by a core clock at the receiver.

In some cases, the frequency of the core clock at transmitter in a first communication device can be different from a frequency of the core clock at the receiver in a second communication device.

In addition, the optical link can be associated with a link frequency, which is the frequency at which data signals are communicated over the optical link. The link frequency of data signals in a first direction from a first communication device to a second communication device over the optical link can differ from the link frequency of data signals from the second communication device to the first communication device over the optical link.

Due to the potential presence of different core clock frequencies and link frequencies in different directions over the optical link, there may initially be a lack of synchronization between a particular pair of a transmitter and a receiver in respective communication devices coupled to the two ends of an optical link. If synchronization between the transmitter and the receiver is not present, then a link training process cannot be successfully performed between the transmitter and the receiver over the optical link. A link training process can involve sending a predefined training pattern (referred to more generally as “training data”) from the transmitter to the receiver, to allow for the capabilities of the transmitter and the receiver to be determined, to negotiate link frequency, and so forth. If the transmitter and receiver are not synchronized, one of the transmitter and receiver may not be ready to transmit or receive data, respectively. In such a scenario, link training would fail since the training data would not be properly communicated between the transmitter and the receiver. In some examples, link training may be based on a timer-based protocol, where timer-based state transitions are used in the transmitter and receiver during the link training. Lack of synchronization between the transmitter and receiver would lead to the timer-based state transitions at the transmitter and receiver going out-of-sync.

In accordance with some implementations, techniques or mechanisms are provided to allow for an initial synchronization point to be identified before a link training process is started between a transmitter and a receiver. The initial synchronization can be achieved despite the fact that the transmitter and receiver coupled over an optical link may be associated with different core clock frequencies, and despite the fact that the link frequencies in a first direction over the optical link may differ from the link frequency in a second, opposite direction over the optical link.

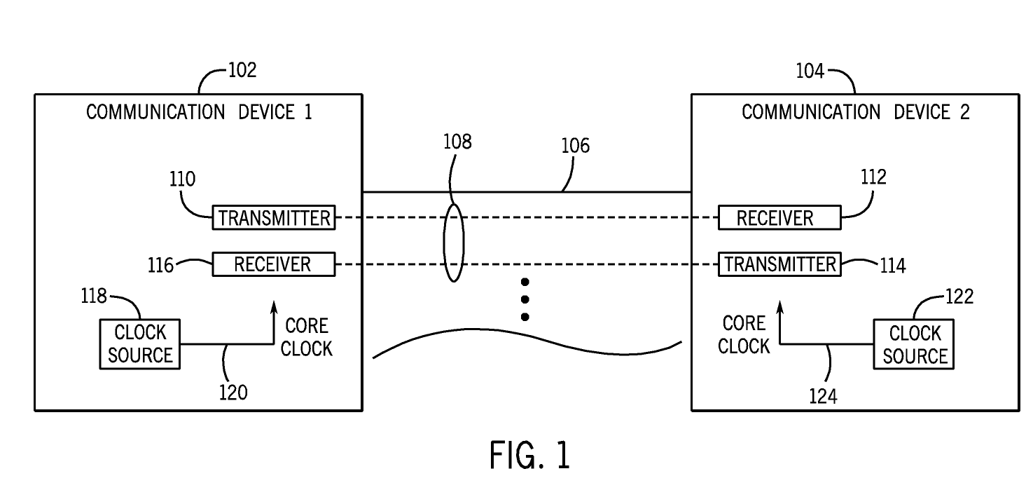

FIG. 1 is a schematic diagram of an example arrangement that includes a first communication device 102 and a second communication device 104 coupled over an optical link 106. The optical link 106 can have multiple lanes 108 (e.g. multiple optical fibers, multiple optical waveguides, etc.). Just one lane 108 of the optical link 106 is depicted in FIG. 1. Each lane 108 can communicate optical signals in both directions between the communication devices 102 and 104. To communicate optical signals from the communication device 102 to the communication device 104, a transmitter 110 in the communication device 102 is used to transmit optical signals over the lane 108 to a receiver 112 in the communication device 104. In the opposite direction, a transmitter 114 in the communication device 104 transmits optical signals over the lane 108 for receipt by a receiver 116 in the communication device 102. The remaining lanes 108 of the optical link 106 are each associated with respective sets of transmitters and receivers similar to 110, 112, 114, and 116.

The first communication device 102 includes a clock source 118 that outputs a core clock 120. Similarly, the second communication device 104 includes a clock source 122 that outputs a core clock 124. The core clock 120 is used by the transmitter 110 and receiver 116 in the first communication device 102, while the core clock 124 is used by the receiver 112 and the transmitter 114 in the second communication device 104. The frequency of the core clock 120 that is associated with the transmitter 110 and receiver 11 in the first communication device 102 can be different from the frequency of the core clock 124 in the second communication device 104. Moreover, it is noted that the link frequency between the communication devices 102 and 104 in a first direction over the lane 108 can differ from a link frequency in a second direction over the lane 108.

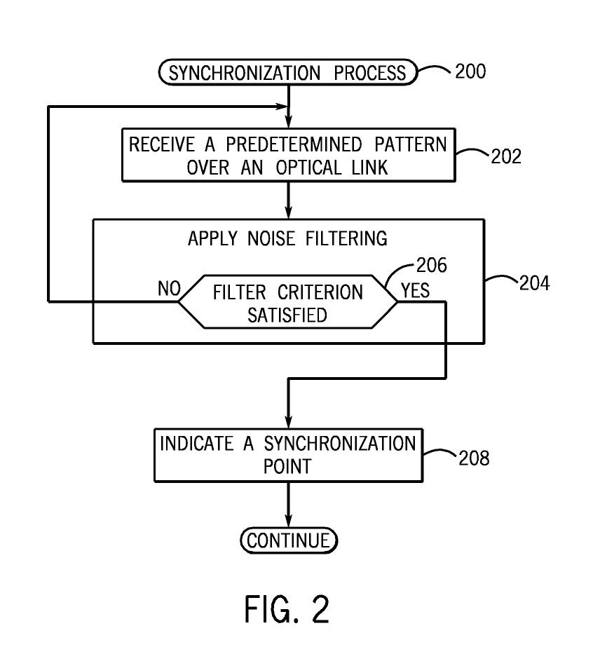

Before a link training process can begin over a given lane 108, an initial synchronization point between a transmitter and receiver in the respective communication devices 102 and 104 is first identified. FIG. 2 is a flow diagram of a synchronization process 200 according to some implementations for identifying this initial synchronization point. The synchronization process 200 can be performed by the receiver 112 in the second communication device 104, or by the receiver 116 in the first communication device 102, according to some examples. The synchronization process 200 is individually performed for each of the lanes 108 of the optical link 106.

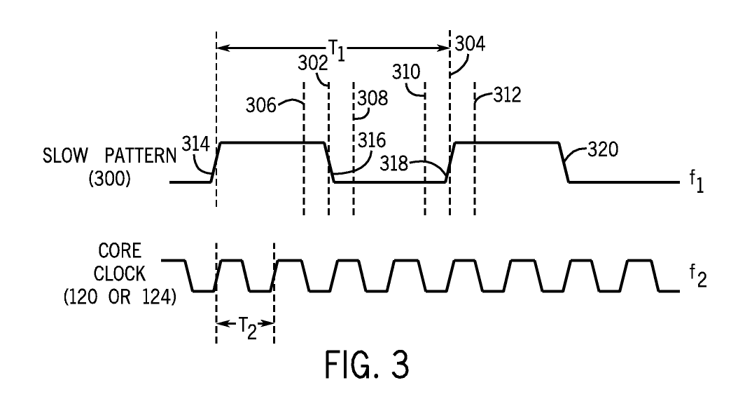

The receiver receives (at 202) a predetermined pattern over a given lane 108 of the optical link 106 from the respective transmitter (e.g. transmitter 110 or transmitter 114). The predetermined pattern can include a sequence of edge transitions (low-to-high edge transition and high-to-low edge transition). An example of a predetermined pattern 300 is depicted in FIG. 3. The frequency (f₁) of the predetermined pattern 300, as shown in FIG. 3, is lower than the corresponding core clock frequency f₂ (frequency of the core clock 120 or 124). The predetermined pattern 300 can be referred to as a “slow pattern,” since it has a frequency f₁ that is less than the core clock frequency f₂. The frequency f₁ of the slow pattern 300 corresponds to a first period T₁, while the frequency f₂ of the core clock corresponds to a second period T₂. In some implementations, the period T₁ of the slow pattern 300 can include a programmable number of core clock periods T₂. This programmable number can be statically or dynamically specified. In some examples, this programmable number can be varied. In the example of FIG. 3, the slow pattern period T₁ includes four core clock periods T₂.

In the synchronization process 200, the receiver applies noise filtering (at 204) to the received predetermined pattern (e.g. 300 in FIG. 3). Noise can result from transient events, such as glitches at the transmitter, receiver, or in the optical link. Noise can also be caused by other factors, such as interference from an external source. Identifying a synchronization point in the presence of noise that excessively distorts the predetermined pattern can lead to inaccurate results. Applying the noise filtering (at 204) allows for the identification of a “valid” predetermined pattern to use for the purpose of identifying a synchronization point. As discussed further below, the filtering applied at 204 can include filtering in multiple stages.

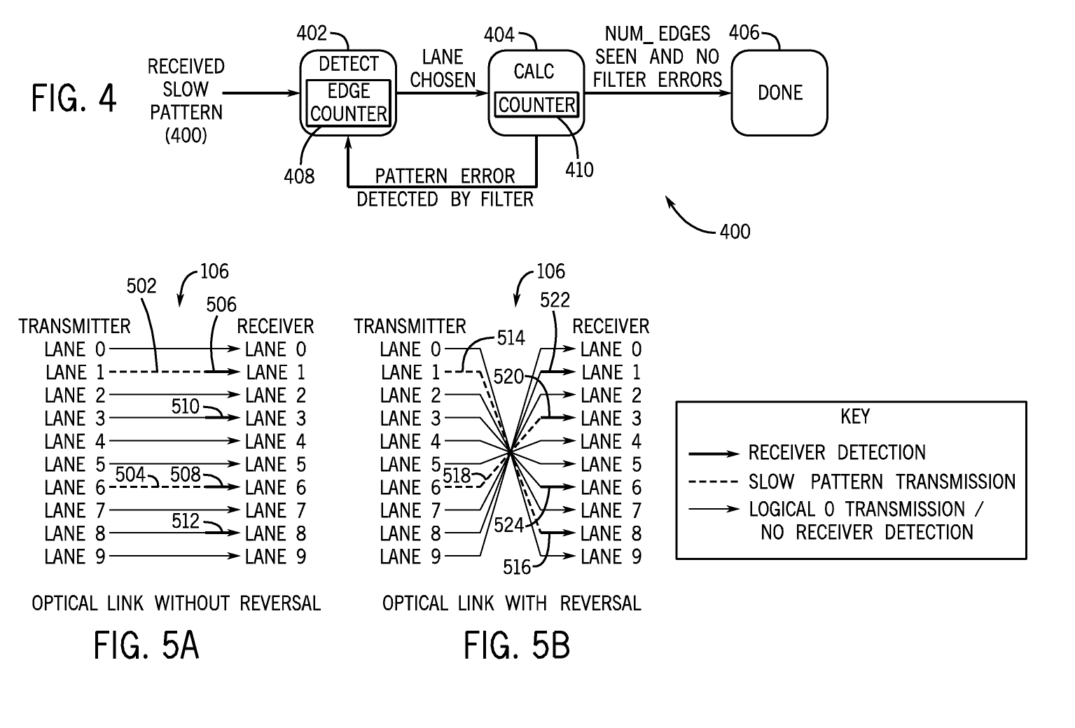

A “valid” predetermined pattern is one that satisfies at least one filter criterion (discussed further below in connection with FIG. 4). For example, excessive noise in a received predetermined pattern may cause the predetermined pattern to not satisfy the at least one filter criterion, in which case the received predetermined pattern should not be used.

As part of the noise filter application (at 204), the receiver determines (at 206) whether the at least one filtering criterion is satisfied. In implementations where the filtering is performed in multiple stages, the determination (at 206) of whether the at least one filtering criterion is satisfied can be performed at each of the multiple stages. Further details regarding the determination at 206 are discussed further below in connection with FIG. 4.

In response to determining that the predetermined pattern satisfies the at least one filtering criterion, the receiver indicates (at 208) that a synchronization point has been reached between the transmitter and receiver to allow link training to proceed with respect to the given lane. On the other hand, in response to detecting that the predetermined pattern does not satisfy the at least one filtering criterion, the receiver returns to task 202 to re-iterate the synchronization process 200 using another predetermined pattern.

FIG. 4 illustrates a state machine 400 that can be provided in a receiver (e.g. receiver 112 or 116 in FIG. 1) to perform multiple filtering stages (as part of the filtering applied at 204 in FIG. 2). In some implementations, the state machine 400 has the following states: Detect, Calc, and Done. A first filtering stage is applied in the Detect state 402, while another filtering stage is applied in the Calc state 404. Note that the filtering stages are applied on a per-lane basis in some implementations.

The first filtering stage of the Detect state 402 receives a slow pattern (300). The first filtering stage checks that each of a predetermined number of transition edges (e.g. 314, 316, 318, and 320 in FIG. 3) in the slow pattern 300 occurs within a predefined time interval since the immediate last transition edge. For example, the first filtering stage checks that the transition edge 316 occurs within a predefined time interval (e.g. an interval defined between time points represented by vertical dashed lines 306 and 308 in FIG. 3) from the last transition edge 314. Similarly, the first filtering stage checks that the transition edge 318 occurs within the predefined time interval (e.g. an interval defined between time points represented by vertical dashed lines 310 and 312 in FIG. 3) from the last transition edge 316.

In some examples, the predefined time interval can be expressed using the following parameters: PERIOD_MIN and PERIOD_MAX. PERIOD_MIN defines the leading edge of the predefined time interval, while PERIOD_MAX defines the lagging edge of the predefined time interval. In some examples, PERIOD_MIN and PERIOD_MAX can be expressed as respective numbers of core clock periods. In other examples PERIOD_MIN and PERIOD_MAX can be expressed in terms of absolute time.

For a given transition edge (e.g. 316 in FIG. 3), the first filtering stage of the Detect state 402 determines whether the given transition edge occurs at a point that is greater than or equal to PERIOD_MIN core clock cycles since the last transition edge (e.g. 316), and less than or equal to PERIOD_MAX number of core clock cycles since the last transition edge. If the foregoing relationship, expressed as PERIOD_MIN≦NUMBER OF CORE CLOCK CYCLES SINCE LAST TRANSITION EDE≦PERIOD_MAX, is satisfied, then the slow pattern 300 is considered valid for continued processing by the first filtering stage. However, if the above relationship is not satisfied, which means that a transition edge of the slow pattern 300 is outside the predefined interval from the last transition edge, then the currently processed slow pattern 300 is rejected, and the state machine 400 resets to restart the synchronization process at the Detect state 402.

If a given transition edge occurs within the predefined interval defined by PERIOD_MIN and PERIOD_MAX, then an edge counter 408 associated with the Detect state 402 is incremented. The foregoing process continues for each subsequent transition edge of the slow pattern 300. The edge counter 408 is incremented each time a subsequent transition edge falls within the predefined interval from the last transition edge. When the edge counter 408 reaches a predefined count number (which can be expressed in a parameter EDGE_COUNT, for example), then the state machine 400 can transition from the Detect state 402 to the Calc state 404.

Once the edge counter 408 reaches the predefined count number in EDGE_COUNT, then the first filter stage of the Detect state 402 is considered to have observed the EDGE_COUNT number of transition edges in the slow pattern 300, where each of such transition edges satisfies the criterion of occurring within the predefined time interval (defined by PERIOD_MIN and PERIOD_MAX) from the last transition edge.

The transition from the Detect state 402 to the Calc state 404 is an indication that the lane over which the slow pattern 300 was received is chosen for purposes of the synchronization process.

A second filtering stage is applied in the Calc state 404. In some examples, the second filtering stage can include two filters. The second filtering stage samples data on the chosen lane, where the sampled data includes the slow pattern 300 on the chosen lane.

The two filters of the second filtering stage can operate independently of each other, and can be applied on the same sampled data (or alternatively, different sampled data). The first filter of the second filtering stage checks the slow pattern 300 for short-term instability of the slow pattern 300, while the second filter of the second filtering stage checks the slow pattern 300 for long-term instability. The state machine 400 remains in the Calc state 404 so long as the second filtering stage determines that the slow pattern 300 on the chosen lane satisfies the filter criteria of the first and second filters, until the following condition occurs: a predefined number (represented in a parameter NUM_EDGES, for example) of transition edges of the slow pattern 300 have been detected. If the slow pattern 300 on the chosen lane violates either of the filter criteria of the first and second filters of the second filtering stage, then the state machine 400 resets and returns to the Detect state 402.

In some implementations, the first filter of the second filtering stage checks that the length between a particular pair of slow pattern transition edges is within ±m (m≧1) core clock cycles of the length between a preceding pair of slow pattern transition edges. For example, in FIG. 3, the first filter checks that the length between the pair of transition edges 316, 318 is ±m core clock cycles of the length between the preceding pair of transition edges 314, 316. Similarly, the first filter would check that the length between the pair of transition edges 318, 320 is ±m core clock cycles of the length between the preceding pair of transition edges 316, 318.

Assuming m=2, then the following slow pattern sequence (where each digit corresponds to one core clock cycle) would satisfy the first filter criterion:

000001110000111111 . . .

In the foregoing sequence, each occurrence of “01” corresponds to a low-to-high transition edge, and each occurrence of “10” corresponds to a high-to-low transition edge. In the sequence, the first portion (00000) is five core cycles long, the second portion (111) is three core clock cycles long (which is within ±2 of five), the third portion (0000) is four core clock cycles long (which is within ±2 of three), and the fourth portion (111111) is six core clock cycles long (which is within ±2 of four).

However, assuming m=2, then the following slow pattern sequence would not satisfy the first filter criterion:

00000111000000111111 . . .

This sequence is the same as the former sequence, except that the third portion (000000) is six core clock cycles long, which is not within ±2 of three (which is the length of the second portion, 111).

Effectively, as noted above, the first filter checks for short-term instability in the slow pattern 300. If there is excessive variation (greater than ±m core clock cycles) in the lengths of successive pairs of transition edges, then that indicates that there is short term instability in the slow pattern 300. If short-term instability is detected, then the first filter criterion is violated, and the state machine 400 resets.

As noted above, the second filter of the second filtering stage checks for long-term instability in the slow pattern 300. The second filter determines whether lengths of successive sets of slow pattern transition edges are within ±p core clock cycles of each other. A set of slow pattern transition edges can include some predefined number (three or more, for example) of transition edges. Assuming the predefined number of transition edges is four, then the following would be an example set of transition edges of the slow pattern 300:

000111000111.

The above example first set is 12 core clock cycles long.

Assuming that p=1, the following second set (that immediately follows the above set in the slow pattern 300) would satisfy the second filter criterion:

00011000111.

The second set above is 11 core clock cycles long, which is within ±1 (note p=1 in this example) length (in terms of core clock cycles) of the first set.

However, the following third set (that immediately follows the second set) would not satisfy the second filter criterion:

0001110000111.

The third set is 13 core clock cycles long, which is not within ±1 of the length (in terms of core clock cycles) of the second set.

In the Calc state 404, a counter 410 is used to count the number of core clock cycles (at the receiver) it takes to receive a predefined number (NUM_EDGES) of transition edges in the slow pattern 300. This count value of the counter 410 corresponds to the ratio of the receiver link frequency to the receiver core frequency. The ratio can either be set equal to the count value of the counter 410, or be derived from the count value of the counter 410. The ratio can be used during link training to keep both sides of the optical link in synchronization. It is noted that the ratio can also be used to maintain optical link synchronization during other operations over the optical link that involve the transmitter and receiver.

Once the state machine 400 has detected NUM_EDGES transition edges and slow pattern 300 satisfies the filtering criteria of the second filtering stage, the state machine 400 transitions from the Calc state 404 to the Done state 406.

An example of how the ratio noted above can be used to keep both sides of the optical link in synchronization is discussed here. Once the Calc state is complete in the receiver at each side of an optical link, the corresponding receiver has its corresponding ratio, which effectively represents the number of receiver core clock cycles per slow pattern period. For example, a slow pattern period can have 7.5 receiver core clock cycles (Ratio 1) at a first side of the optical link, and can have 5 receiver core clock cycles (Ratio 2) at a second side of the optical link. The ratio information (Ratio 1 and Ratio 2) can be used for timer-based (also referred to as counter-based) link training state transitions. A link training state transition can refer to a transition of a state machine used in performing a link training procedure.

As an example, a link training state transition on either side of the optical link can occur after a programmable number (e.g. 10) of slow pattern periods. In this example, the state transition on a given side occurs after the time it takes for the transmitter to transmit 10 slow pattern periods or to receive 10 slow pattern periods, whichever is longer. Note that the transmitter does not have to be transmitting the slow pattern anymore, and can be transmitting data at the full link rate. In the foregoing example where it is assumed that Ratio 1 is 7.5 and Ratio 2 is 5, in performing a link training procedure, the first side waits 7.5*10 (=75) core clock cycles or waits for the transmitter to send 10 slow pattern periods worth of data (whichever is longer) before making a state transition, while the second side waits 5*10 (=50) core clock cycles or waits for the transmitter to send 10 slow pattern periods worth of data (whichever is longer) before making a state transition. Since the receivers and transmitters at both sides of the optical link perform state transitions in accordance with the above, the sides can remain synchronized with each other.

FIGS. 5A and 5B depict examples where the optical link 106 of FIG. 1 has 10 lanes (lanes 0 through 9). In an example depicted in FIG. 5A, a slow pattern can be transmitted over two of the 10 lanes, such as over lane 1 and lane 6 (as indicated by dashed lines 502 and 504, respectively). The slow pattern is not transmitted over each of the remaining lanes to avoid inter-lane interference.

In FIG. 5A, the transmitted slow patterns on lanes 1 and 6 are detected by respective receivers on lanes 1 and 6, as indicated by arrows 506 and 508. No pattern is transmitted over lanes 0, 2-5, and 7-9, in which case the respective receivers on those lanes do not detect a slow pattern. Note also that, in FIG. 5A, receiver detection is also attempted on lanes 3 and 8 (as represented by arrows 510 and 512). However, since no optical transmission was performed on lanes 3 and 8, no optical signal is detected by the receiver detection attempted at 510 and 512. In the example of FIG. 5A, the receiver detection is attempted on each of lanes 1, 3, 6, and 8, since the receiver does not know if the optical link 106 is reversed (discussed below) or if there is a broken lane which caused the optical link 106 to have a reduced width. If the optical link 106 is not reversed, then lane 1 or 6 can be chosen to perform link training.

Note that if one of the lanes over which a slow pattern is broken (e.g. lane 6), then the optical link 106 can still be trained using the other lane, at half width.

Although slow patterns are transmitted over a specific combination of lanes in FIG. 5A, it is noted that in other examples, slow patterns can be transmitted over other combinations of lanes.

FIG. 5A shows the optical link 106 without lane reversal (in other words, an optical signal sent by a transmitter on lane i is received by a receiver on lane i). However, FIG. 5B shows the optical link 106 with lane reversal (in other words, an optical signal sent by a transmitter on lane i is received by a receiver on a different lane). Lane reversal can be caused by use of an optical connector or other type of optical interconnecting structure that reverses the connections of lanes at the transmitter side to the lanes at the receiver side.

Lane reversal in the example of FIG. 5B results in the transmitter on lane 0 being connected to the receiver on lane 9, the transmitter on lane 1 being connected to the receiver on lane 8, and so forth. Thus, in the FIG. 5B example, a slow pattern sent by a transmitter on lane 1 (indicated by dashed line 514) is detected by a receiver on lane 8 (indicated by 516). Similarly, a slow pattern sent by a transmitter on lane 6 (indicated by dashed line 518) is detected by a receiver on lane 3 (indicated by 520). Although receiver detection is attempted on lanes 1 and 6, no optical signal is detected on those lanes. In case of lane reversal, lane 3 or 8 can be chosen to perform link training.

If a slow pattern is detected on a lane that is a reversed version of the transmission lane, such as detecting a slow pattern on lane 8 at the receiver side when the slow pattern was actually transmitted on lane 1 at the transmitter side, then lane reversal can be indicated. The ability to detect lane reversal of the optical link 106 can be accomplished prior to performing bit lock and symbol lock on the optical link 106 (when synchronization in communication of data bits and symbols has been achieved).

The various tasks discussed above, including those depicted in FIG. 2 or 4, can be performed by physical circuitry, or alternatively by machine-readable instructions executable on a processing circuit. A processing circuit can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a receiver, a predetermined pattern over an optical link from a transmitter;
applying noise filtering, by the receiver, on the received predetermined pattern; and
in response to detecting that the predetermined pattern satisfies at least one criterion, indicating that a synchronization point has been reached to allow link training of the optical link to be performed.

2. The method of claim 1, further comprising:
beginning the link training of the optical link after the synchronization point is indicated.

3. The method of claim 1, wherein the predetermined pattern includes transition edges and has a first frequency less than a second frequency of a clock associated with the receiver.

4. The method of claim 3, wherein the filtering includes:
for each given one of the transition edges of the predetermined pattern,
determining whether the given transition edge occurs within a predetermined time interval from a preceding transition edge of the predetermined pattern;
indicating that the predetermined pattern does not satisfy the criterion in response to determining that the given transition edge occurs outside the predetermined time interval from the preceding transition edge.

5. The method of claim 4, wherein the filtering includes:
indicating that the criterion is satisfied in response to detecting that each of a predefined number of transition edges of the predetermined pattern occurs within a respective predefined time interval from a corresponding preceding transition edge.

6. The method of claim 3, wherein the filtering includes:
determining that a first length of a first pair of transition edges of the predetermined pattern is within a predefined number of cycles of the clock of a second length of a preceding pair of transition edges of the predetermined pattern; and
indicating that the predetermined pattern does not satisfy the criterion in response to determining that the first length is not within the predefined number of cycles of the clock of the second length.

7. The method of claim 3, wherein the filtering includes:
determining that a first length of a first set of transition edges of the predetermined pattern is within a predefined number of cycles of the clock of a second length of a preceding set of transition edges of the predetermined pattern,
indicating that the predetermined pattern does not satisfy the criterion in response to determining that the first length of the first set of transition edges is not within the predefined number of cycles of the clock of the second length of the preceding set of transition edges.

8. The method of claim 3, further comprising:
calculating, by the receiver, a value based on determining a number of cycles of the clock of the receiver that have occurred for a predefined number of the edge transitions in the predetermined pattern.

9. The method of claim 8, further comprising using the value to maintain synchronization between the receiver and transmitter.

10. The method of claim 1, further comprising detecting that the optical link has lane reversal in response to the receiver detecting the predetermined pattern on a particular lane of the optical link that is different from a lane on which the predetermined pattern was transmitted.

11. An apparatus comprising:
a receiver to receive a predetermined pattern over an optical link from a transmitter, wherein the receiver is to further:
determine whether a portion of the predetermined pattern satisfies at least one criterion;
in response to determining that the portion of the predetermined pattern does not satisfy the at least one criterion, disregard the portion; and
in response to determining that the portion of the predetermined pattern satisfies the at least one criterion, process the portion to indicate that a synchronization point between the transmitter and receiver has been reached, to allow link training of the optical link to be performed.

12. The apparatus of claim 11, wherein the receiver includes a state machine to perform the determining, disregarding, and processing, and wherein the state machine is reset in response to detecting that the portion of the predetermined pattern does not satisfy the at least one criterion.

13. The apparatus of claim 12, wherein the state machine has a plurality of states, where first filtering is applied in a first of the plurality of states, and second filtering is applied in a second of the plurality of states, and wherein the first filtering determines whether the predetermined pattern satisfies a first criterion, and wherein the second filtering determines whether the predetermined pattern satisfies a second criterion.

14. The apparatus of claim 13, wherein the first criterion specifies that a given transition edge of the predetermined pattern is to occur within a predefined time interval from a preceding transition edge of the predetermined pattern.

15. The apparatus of claim 13, wherein the second criterion specifies that a length of a particular pair of transition edges of the predetermined pattern is to be within a predefined number of clock cycles of a length of a preceding pair of transition edges of the predetermined pattern.

16. The apparatus of claim 13, wherein the first criterion specifies that a given transition edge of the predetermined pattern is to occur within a predefined time interval from a preceding transition edge of the predetermined pattern.

17. The apparatus of claim 13, wherein the receiver includes a counter to count a number of clock cycles in the receiver that have transpired for a predefined number of transition edges of the predetermined pattern, and wherein the receiver is to compute a value based on the counted number of clock cycles to use for maintaining synchronization between the receiver and the transmitter.

18. A system comprising:
an optical link;
a transmitter to transmit a predetermined pattern over the optical link, the predetermined pattern having a first frequency; and
a receiver to receive the predetermined pattern from the optical link, wherein the receiver has a clock for clocking receive circuitry of the receiver, wherein the clock has a second frequency greater than the first frequency, and wherein the receiver is to:
apply noise filtering on the received predetermined pattern; and
in response to detecting that the predetermined pattern satisfies at least one criterion, indicating that a synchronization point has been reached to allow link training of the optical link to be performed.

19. The system of claim 18, wherein the transmitter has a clock for clocking circuitry of the transmitter that drives an optical element of the transmitter, and wherein a frequency of the clock of the transmitter is different from the first frequency.

20. The apparatus of claim 19, wherein a link frequency over the optical link in a first direction is different from a link frequency over the optical link in a second, opposite direction.
